(19) United States
(12) Patent Application Publication
(10) Pub. No.: US 2008/0016132 A1
(43) Pub. Date: Jan. 17, 2008

(54) IMPROVED DATA DELETION

(75) Inventor: Milan J. Merhar, Brookline, MA (US)

Correspondence Address: HOGAN & HARTSON LLP, ONE TABOR CENTER, SUITE 1500, 1200 SEVENTEEN ST., DENVER, CO, 80202, US

(73) Assignee: SUN MICROSYSTEMS, INC., Santa Clara, CA (US)

(21) Appl. No.: 11/457,747

(22) Filed: Jul. 14, 2006

(51) Int. Cl. G06F 17/30

(52) U.S. Cl. 707/206

(57) ABSTRACT

A data deletion method includes providing a first monitoring/reporting threshold associated with a file to be deleted for reporting that the information in the file is deleted, but is unrecoverable using conventional commands or operations, and providing a second monitoring/reporting threshold associated with the file to be deleted for reporting that the information in the file is deleted, and is not recoverable.

### BACKGROUND OF THE INVENTION

The present invention is related to computer systems, and, more particularly, to an improved method of deleting the data in files used by the computer system.

Computer system vendors produce systems comprised of server, storage array, and application software, which together comprise a Network-Attached Storage appliance (“NAS”). As such, the user-accessible interface to the system consist of a network communications protocol such as NFS and CIFS/SMB, which carry both command instructions such as “read”, “write”, “create file”, and “delete file”, and the data associated with those operations.

Computer system vendors have enhanced this basic NAS functionality by adding support for secure archiving of compliance-related files, following a methodology such as is required for Sarbanes-Oxley, SEC, and FDA regulations for information retention. Such “compliance archiving” solutions in general add three major capabilities: the ability to prevent subsequent alteration of the archived data, the ability to prevent intentional or unintentional erasure of the data for a designated retention period and, once the retention period has passed, the ability to discard the retained data following a documented procedure. This latter capability is the focus of the present invention.

Several methods currently used for deleting data from a file. Deletion of data from a file system, whether a local file system such as used by e.g. Microsoft Windows or a Network File System such as used in a NAS appliance, causes a number of actions to occur. First, the data contained in the file to be deleted is removed from the user's visibility; this “data is gone” aspect is the one most end users associate with deletion. Second, the resources used to store that data are recycled internally within the system for reuse; that is, deleting a 1 Megabyte file from a file system is associated with 1 Megabyte of additional “free space” appearing in that file system which can be used to store other data. However, the actual mechanisms used to recycle those resources vary between file system implementations, and with the level of security associated with both the system and the applications using it. It should be noted that especially in the case of extremely large files that may have been written in multiple incremental events, there may be a considerable number of discrete resources associated with the file, and subsequently a rather complex and lengthy process to return those resources for reuse.

It is known by those skilled in the art that data in a desktop file system such as used for Windows, MacOS, or Linux is not really destroyed on deletion, and a small but thriving business exists for tools capable of “un-deleting” such data. More sophisticated applications may overwrite the data, e.g. with zeroes or random bits, as part of the deletion operation. This thwarts simplistic data recovery tools but not forensic data analysis, which attacks the storage device with tools such as scanning electron microscopes, custom data recovery software, etc to read the residual ghosts of the original data, even though it had been overwritten.

Procedures for truly secure data storage, such as required for confidential or secret information, specify elaborate procedures to be followed when deleting data. For example, the Department of Defense standard 5220.22M specifies that confidential or secret data must be overwritten by a constant data value, overwritten again by the compliment of that data value, and then overwritten a final time with random data. A final pass to read back the data and confirm the writes have occurred is recommended. As the expectation for data security and confidentiality in business is raised, this level of information security may become the defacto standard, rather than the exception.

What is desired is a method for deleting data in a file that is non-recoverable, even using forensic data analysis, and provides feedback and assurances to the user that the data has been deleted in this non-recoverable manner.

### SUMMARY OF THE INVENTION

A data deletion method includes initiating a command to delete a file, finding storage resources associated with the file, overwriting the storage resources associated with the file with a first data value, returning a first completion indication to an application, overwriting the storage resources associated with the file with a second data value, overwriting the storage resources associated with the file with a third data value, returning the storage resources associated with the file to a free pool of storage resources, removing a file entry associated with the file from a file directory, and returning a second completion indication to the application. The first completion indication can include reporting to the application that the file is deleted, but that the data in the file is unrecoverable using conventional commands or operations. The data deletion method of the present invention can include initiating an action in conjunction with the first completion indication. The second completion indication can include reporting to the application that the file is deleted, but that the data in the file is not recoverable. The data deletion method of the present invention can also include initiating an action in conjunction with the second completion indication. Deleting the data in the file can be accomplished by overwriting the storage resources with a fixed data pattern, a random data pattern, or a pattern that is dependent upon the physical characteristics of the storage resource, or a combination of some or all of the three patterns. If desired, the data deletion method of the present invention can include returning an indication from the storage resource that multiple overwriting of the file has been physically completed, and/or instructing the storage resource to perform a physical data destruction operation.

### BRIEF DESCRIPTION OF THE DRAWINGS

The aforementioned and other features and objects of the present invention and the manner of attaining them will become more apparent and the invention itself will be best understood by reference to the following description of a preferred embodiment taken in conjunction with the accompanying drawings, wherein:

FIG. 1 is a block diagram of a computer system showing the environment for the file deletion processing method according to the present invention; and

FIG. 2 is a flow chart for the file deletion processing method of the present invention.

### DETAILED DESCRIPTION

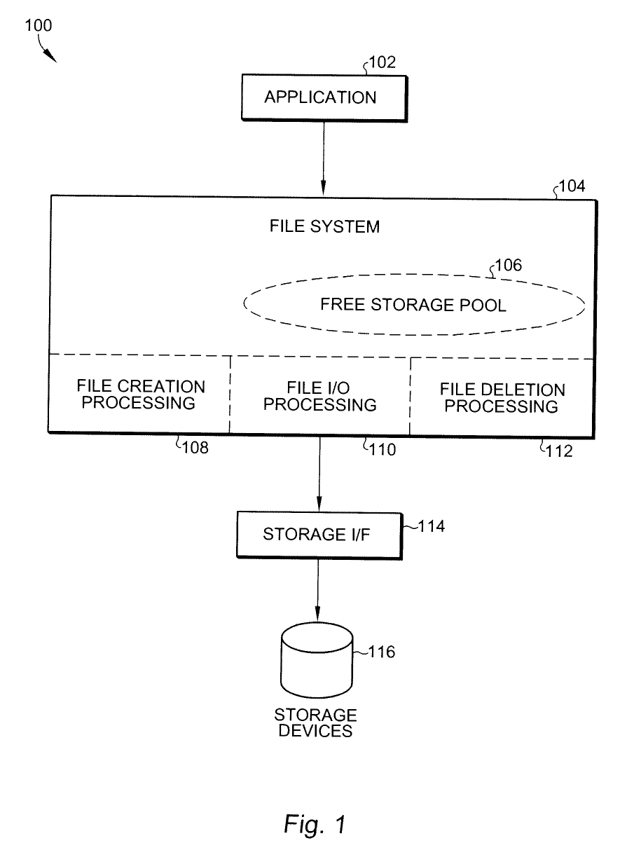

Referring to FIG. 1, a computer system 100 is shown that is the environment for practicing the data deletion method of the present invention. Computer system 100 includes an application 102 in communication with a file system 104. The file system includes free storage pool 106, file creation processing 108, file I/O processing 110, and file deletion processing 112 according to the present invention. The file system 104 is in communication with storage interface 114, which is in turn in communication with storage devices 116. As is known in the art, the various components of the computer system 100 can be realized in hardware or software, and can each be distributed amongst several sub-components.

In the current NAS storage systems such as computer system 100, two different mechanisms are provided to perform basic file deletion operations. The first, here called “background deletion”, attempts to minimize customer-visible application delays associated with the removal of files. When the user application issues a network storage command to delete a file, the NAS storage system responds in the following way:

1) the file is moved from its existing location to a hidden directory, where it is inaccessible to further user access;

2) the protocol message requesting the deletion is acknowledged, notifying the application that the data has been deleted; and

3) as a separate background process, the NAS storage system traverses the contents of the hidden directory, freeing the resources associated with the deleted files, and then removing the file entry from the hidden directory.

Thus, the application is immediately freed to perform additional work, while the actual resources used by the file are returned for reuse over a short period of time thereafter. The hidden directory is used as a temporary record of what files and file resources are in the intermediate state of being considered as deleted, but still holding resources needing to be restored to the free pool.

The second mechanism, here called “immediate deletion”, attempts to minimize the delay in returning file resources for reuse, at the expense of slower application performance. When the user application issues a network storage command to delete a file in this mode, the NAS storage system responds in the following way:

1) all resources associated with the file are freed, and the file entry is removed from its current location; and

2) the protocol message requesting the deletion is acknowledged, notifying the application that the data has been deleted.

In this case the application will stall until such time as all file resources have been freed. For large or complex file structures, this delay may be significant. However, when the application finally is notified that the operation has completed, it may immediately utilize the just-freed resources, rather than having to wait for them to become available at some indefinite time in the future.

The file write and file deletion behaviors of the NAS system are modified if the system has the “Compliance Archiving” capability enabled. In this enhanced feature set, the user application may use a separate means to command the NAS system to convert an existing file and its data contents into a “Write Once, Read Many” or WORM file, which may not be further modified by any means. Basically, the WORM identifier associated with a file inhibits use of any write function, preventing the file from being modified, appended to, or overwritten. Similar logic associated with the deletion function prevents the WORM file from being removed until its “retention period” has expired. At that time, even though the file may still not be modified or overwritten, it may be deleted using either of the modes described above.

The data deletion method of the present invention is described below.

In presentations of the previously described product features to a potential customer, the question was raised as to the ability to access data after deletion, using means such as the “un-delete” tools described above. In particular, their concern was specific to the case where confidential data was held in a Compliance Archive WORM file through its retention period, and then the system was authorized to delete it.

In the existing product implementation, the storage resources previously used to hold the information in a deleted file are still intact after being returned to the “free space pool” and not initialized to zero until actually taken from the pool for reuse. Thus, they are theoretically exposed to observation or recovery via a purpose-build “un-delete” tool. However, as the internal data structures of the file system used in these products differ from other commercial implementations (i.e. Microsoft Windows NTFS, Sun Solaris UFS, etc.) there is no known risk from any existing or commercially available tool.

A mechanism to mitigate this potential risk is desired; the storage resources associated with such confidential files should be overwritten before those resources are returned to the free storage pool for reuse. However, extending that concept from a simple overwrite (e.g. with a fixed data “zero” value, such as is already performed by the current implementation when those resources are actually reused) to a DoD 5220.22M secure deletion raises considerable implementation difficulties, resolution of which is not obvious.

The difficulty stems from the sequential nature of the DoD secure deletion. To function correctly, the commands to perform the first write must absolutely complete before the commands to perform the second write are issued, etc. This is because of the nature of modern storage systems, being comprised of multiple layers of software intelligence and caching memory buffers. In the best case, these layers improve performance by eliminating inefficient sequences of operations, and by processing information from fast memory buffers rather than slow rotating media. In the worst case, these same algorithms will silently eliminate “unneeded” operations—for example, responding to the operation sequence “write data value 0 to location X”, “write data value 1 to location X”, “write data value 2 to location X by ignoring the writes of 0 and 1, and directly writing the value 2. This is logically correct in terms of the resulting data at location X, but dismisses the essential value of the previous two writes in eliminating secondary traces of information, which in the case of DoD 5220.22M is being relied upon to insure proper behavior. Thus, it is essential that an “erasure state value” be associated with the erasure process for each file being erased, so that its progress through the multiple phases of the process can be monitored and scheduled appropriately.

In the existing implementation, such an erasure state value is optimally associated with a file in the hidden background deletion directory, for the following reasons:

the file is securely removed from access by user application programs, and thus may be overwritten with impunity;

the act of moving the file from the user accessible directory space to this special directory (along with appropriate permissions checks e.g. that the file actually has passed its required retention time) can be used as a secure gate on re-enabling of the overwrite and modify capabilities that were removed from the file when it was converted into a WORM file; and

the system model already supports the concepts and provides the mechanisms for independent processes walking through the set of files, performing actions upon them.

In the current implementation, the background process is relatively straightforward, executing the following pseudo-code:

```
for each file in the special deletion directory,
  find a storage resource associated with the file,
    return the storage resource to the free pool
  next storage resource
  remove the file's entry from the directory,
next file
```

In the proposed implementation the operation of the background process is extended, as shown by the following example pseudo-code:

```
for each file in the special deletion directory,
  switch to an action case based on the erasure state associated with
  this file
    Case “none”
      create an erasure state of “overwrite pass 1”
      for each storage resource associated with the file
        set the contents of the storage resource to “overwrite value 1”
      next storage resource
      end case
    Case “overwrite pass 1”
      set erasure state to “overwrite pass 2”
      for each storage resource associated with the file
        set the contents of the storage resource to “overwrite value 2”
      next storage resource
      end case
    Case “overwrite pass 2”
      set erasure state to “overwrite pass 3”
      for each storage resource associated with the file
        set the contents of the storage resource to “overwrite value 3”
      next storage resource
      end case
    Case “overwrite pass 3”
      set erasure state to “deletion”
      for each storage resource associated with the file
        return the storage resource to the free pool
      next storage resource
      end case
    Case “deletion”
      remove the file's entry (including erasure state) from the
      directory
      end case
  end switch
next file
```

Thus, the scheduled deletion of confidential data stored in a compliant archive is performed in a secure manner.

The more significant portion of the invention lies in how this admittedly lengthy process relates to the behavior of the client application program which actually requested the file deletion. Recall from the previous description that the current implementation supports two options; that the application continue immediately, with the deletion occurring in the background, or that the implementation be forced to wait until the deletion has completed. This invention proposes an additional option, that the application be forced to wait until the contents of the file is overwritten sufficiently to constitute (in the words of the customer to which it was proposed,) “plausible deniability” of access to the file. That is, at the time that the application is informed that the deletion request has occurred, the previous contents of the file on disk have been sufficiently disrupted that any reasonable attempt to recover it using software tools etc. would fail. However, continued data destruction efforts will continue on the file after that time, resulting in a fully DoD 5220.22M behavior for the overall system.

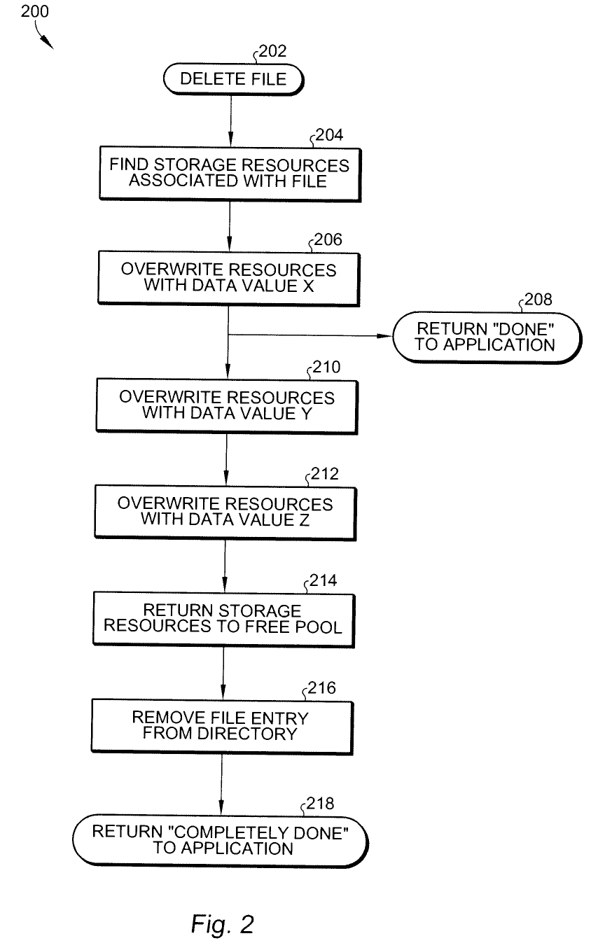

Referring now to FIG. 2, a simplified block diagram is provided of the data deletion method of the present invention. The data deletion method 200 includes initiating a command to delete a file 202, finding storage resources associated with the file 204, overwriting the storage resources associated with the file with a first data value 206, returning a first completion indication to an application 208, overwriting the storage resources associated with the file with a second data value 210, overwriting the storage resources associated with the file with a third data value 212, returning the storage resources associated with the file to a free pool of storage resources 214, removing a file entry associated with the file from a file directory 216, and returning a second completion indication to the application.

The first completion indication can include reporting to the application that the file is deleted, but that the data in the file is unrecoverable using conventional commands or operations. The data deletion method of the present invention can include initiating an action in conjunction with the first completion indication. The second completion indication can include reporting to the application that the file is deleted, but that the data in the file is not recoverable. The data deletion method of the present invention can also include initiating an action in conjunction with the second completion indication. Deleting the data in the file can be accomplished by overwriting the storage resources with a fixed data pattern, a random data pattern, a pattern that is dependent upon the physical characteristics of the storage resource, a combination of some or all of the three patterns or a pattern that uses the bit-level encoding method used by the medium to provide a write pattern with optimum overwriting characteristics. If desired, the data deletion method of the present invention can include returning an indication from the storage resource that multiple overwriting of the file has been physically completed, and/or instructing the storage resource to perform a physical data destruction operation.

While there have been described above the principles of the present invention in conjunction with specific components, circuitry and bias techniques, it is to be clearly understood that the foregoing description is made only by way of example and not as a limitation to the scope of the invention. Particularly, it is recognized that the teachings of the foregoing disclosure will suggest other modifications to those persons skilled in the relevant art. Such modifications may involve other features which are already known per se and which may be used instead of or in addition to features already described herein. Although claims have been formulated in this application to particular combinations of features, it should be understood that the scope of the disclosure herein also includes any novel feature or any novel combination of features disclosed either explicitly or implicitly or any generalization or modification thereof which would be apparent to persons skilled in the relevant art, whether or not such relates to the same invention as presently claimed in any claim and whether or not it mitigates any or all of the same technical problems as confronted by the present invention. The applicants hereby reserve the right to formulate new claims to such features and/or combinations of such features during the prosecution of the present application or of any further application derived therefrom.

1. A data deletion method comprising:
initiating a command to delete a file;
finding storage resources associated with the file;
overwriting the storage resources associated with the file with a first data value;
returning a first completion indication to an application;
overwriting the storage resources associated with the file with a second data value;
overwriting the storage resources associated with the file with a third data value;
returning the storage resources associated with the file to a free pool of storage resources;
removing a file entry associated with the file from a file directory; and
returning a second completion indication to the application.

2. The data deletion method of claim 1 wherein returning a first completion indication comprises reporting to the application that the file is deleted, but that the data in the file is unrecoverable using conventional commands or operations.

3. The data deletion method of claim 1 further comprising initiating an action in conjunction with the first completion indication.

4. The data deletion method of claim 1 wherein returning a second completion indication comprises reporting to the application that the file is deleted, but that the data in the file is not recoverable.

5. The data deletion method of claim 1 further comprising initiating an action in conjunction with the second completion indication.

6. The data deletion method of claim 1 further comprising overwriting the storage resources at least once with a fixed data pattern.

7. The data deletion method of claim 1 further comprising overwriting the storage resources at least once with a random data pattern.

8. The data deletion method of claim 1 further comprising overwriting the storage resources at least once with a pattern dependent upon the physical characteristics of the storage resource.

9. The data deletion method of claim 1 further comprising returning an indication from the storage resource that overwriting with the third data value has been physically completed.

10. The data deletion method of claim 1 wherein at least one overwriting operation comprises instructing the storage resource to perform a physical data destruction operation.

11. A data deletion method comprising:
providing a first monitoring/reporting threshold associated with a file to be deleted for reporting that the information in the file is deleted, but is unrecoverable using conventional commands or operations; and
providing a second monitoring/reporting threshold associated with the file to be deleted for reporting that the information in the file is deleted, and is not recoverable.

12. The data deletion method of claim 11 wherein the first monitoring/reporting threshold comprises a variable threshold.

13. The data deletion method of claim 11 further comprising initiating an action in conjunction with the first monitoring/reporting threshold.

14. The data deletion method of claim 11 wherein the second monitoring/reporting threshold comprises a variable threshold.

15. The data deletion method of claim 11 further comprising initiating an action in conjunction with the second monitoring/reporting threshold.

16. The data deletion method of claim 11 further comprising overwriting storage resources associated with the file at least once with a fixed data pattern.

17. The data deletion method of claim 11 further comprising overwriting storage resources associated with the file at least once with a random data pattern.

18. The data deletion method of claim 11 further comprising overwriting storage resources associated with the file at least once with a pattern dependent upon the physical characteristics of the storage resource.

19. The data deletion method of claim 11 further comprising returning an indication from a storage resource associated with the file that multiple overwriting of the storage resource has been physically completed.

20. The data deletion method of claim 11 wherein at least one overwriting operation comprises instructing a storage resource associated with the file to perform a physical data destruction operation.
